(19) United States
(12) Patent Application Publication
(10) Pub. No.: US 2013/0092674 A1
(43) Pub. Date: Apr. 18, 2013

(54) ELECTRODES INCORPORATING METALLIC COATED PARTICLES AND METHODS THEREOF

(71) Applicant: LINCOLN GLOBAL, INC., Industry, CA (US)

(72) Inventors: Gregory A. GERTH, Kirtland, OH (US); Badri K. NARAYANAN, Mayfield Heights, OH (US); Paul E. DENNEY, Bay Village, OH (US); Vaidyanath Bharata RAJAN, Mentor, OH (US)

(73) Assignee: LINCOLN GLOBAL, INC., Industry, CA (US)

(21) Appl. No.: 13/709,684

(22) Filed: Dec. 10, 2012

Related U.S. Application Data
(63) Continuation-in-part of application No. 12/478,849, filed on Jun. 5, 2009, now Pat. No. 8,330,078.

(51) Int. Cl. B23K 35/02

(52) U.S. Cl. CPC B23K 35/0205
USPC 219/145.21

(57) ABSTRACT

A welding wire electrode includes a metal sheath including a core and a core material contained within the core of the metal sheath. The core material includes particles of at least one metal alloying compound, wherein each of the particles has an outer surface, and wherein at least one layer of a metallic coating is deposited onto the outer surface of the particles to form a metallic coated particle.

### CROSS-REFERENCE TO RELATED APPLICATIONS

This application claims priority from U.S. patent application Ser. No. 12/478,849 filed on 5 Jun. 2009, the application being hereinby fully incorporated by reference.

### TECHNICAL FIELD OF THE INVENTION

Welding wire electrodes and methods are provided for improved weld performance. More particularly, welding wire electrodes and methods incorporating materials having at least one layer of a metallic coating on particles of a core material contained within the core of a metal sheath are provided.

### BACKGROUND OF THE INVENTION

Conventional electrodes and methods of manufacturing such electrodes have been available for years. However, while such conventional electrodes and methods somewhat exclude nitrogen and oxygen from entering a weld during a welding process, they do not sufficiently exclude nitrogen and oxygen from a welding arc plasma.

In a flux-cored arc welding process (FCAW), core materials contained within the core of a metal sheath, including flux compounds and alloying compounds, are affected by reactions of high temperature and oxidation in the arc during the welding process. Ultimately, these reactions result in deleterious modifications to the properties of the core material and deposited weld metal.

### SUMMARY OF THE INVENTION

In accordance with one embodiment, a welding wire electrode is provided. The welding wire electrode comprises a metal sheath including a core, and a core material contained within the core of the metal sheath, wherein the core material includes particles of at least one metal alloying compound, wherein each of the particles has an outer surface, and wherein at least one layer of a metallic coating is deposited onto the outer surface of each particle to form a metallic coated particle.

In accordance with another embodiment, a method of hard surfacing a metal workpiece is provided. The method comprises the steps of providing a metal workpiece, preparing a particulate metal alloying compound including a plurality of particles, wherein each of the particles has an outer surface, and wherein at least one layer of a metallic coating is deposited onto the outer surface of each particle to form a metallic coated particle, preparing a core material including the metallic coated particles, forming a cored wire electrode by placing the core material into a metal sheath, feeding the cored wire electrode toward the workpiece, and means for welding to create a weld puddle and deliver the cored wire electrode into the weld puddle, wherein at least a portion of the cored wire electrode is melted and the metallic coated particles are deposited into the weld puddle.

In accordance with yet another embodiment, a welding wire electrode for use with a hot wire welding process is provided. The electrode comprises a metal sheath including a core, and a core material contained within the core of the metal sheath, wherein the core material includes particles of at least one metal alloying compound, wherein each of the particles has an outer surface, wherein at least one layer of a metallic coating is deposited onto the outer surface of each particle by a vapor deposition process to form a metallic coated particle, and wherein each of the metallic coated particles are deposited into a weld puddle formed during the hot wire welding process.

### BRIEF DESCRIPTION OF THE DRAWINGS

While the specification concludes with claims particularly pointing out and distinctly claiming the invention, it is believed that the same will be better understood from the following description taken in conjunction with the accompanying drawing in which:

FIG. 1 is a cross-sectional view depicting a welding electrode in accordance with one embodiment of the invention; and

FIG. 2 is a cross-sectional view depicting a welding electrode in accordance with another embodiment of the invention.

### DETAILED DESCRIPTION OF THE INVENTION

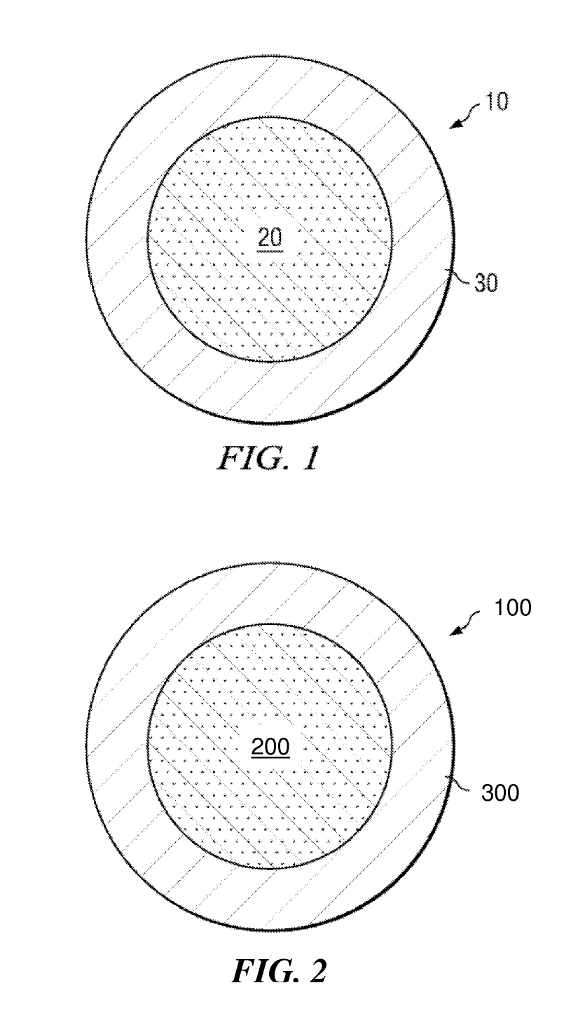

Selected embodiments are herein described in detail in connection with the drawing of FIG. 1. FIG. 1 illustrates a cross-section of a welding electrode 10. Welding electrode 10, as illustrated in FIG. 1, depicts an embodiment of a flux-cored electrode in which a flux portion 20 can be substantially surrounded by a metallic electrode portion 30 and the flux portion 20 can serve as a core of the electrode 10. In the configuration represented in FIG. 1, the flux portion 20 can be employed to provide a shielding gas during a welding operation in order to exclude nitrogen from entering a weld metal, which can be accomplished by shielding air from the weld pool during the welding operation. These types of welding electrodes are generally known as self-shielding electrodes. Self-shielding electrodes are used in many different types of welding operations, such as flux-cored arc welding (“FCAW”). In one embodiment, a flux portion can range from about 5% to about 50% by weight of an electrode. In another embodiment, a flux portion can range from about 10% to about 30% by weight of an electrode.

In a welding process, an electrode generates its own shielding gas, via a material forming a flux portion, to remove oxygen and nitrogen from the area of the molten weld pool. A shielding gas is generated by compounds contained in a flux portion which decompose and/or vaporize during welding. The released gas reduces the partial pressure of nitrogen and oxygen in the welding arc environment so that absorption of nitrogen and oxygen from the weld pool is reduced.

To achieve the exclusion of nitrogen from a weld metal, conventional self-shielding electrodes contain a certain quantity of aluminum in either a flux portion, a metallic electrode portion, or both portions. The presence of aluminum aids in blocking nitrogen and oxygen from the weld metal and preventing brittle welds, which are undesirable in many applications. As such, an electrode is needed having a composition which blocks the entry of nitrogen into a weld metal and does not close or significantly interfere with the phase transfer of a weld metal during a welding operation.

In one embodiment, a flux portion can include a material which includes particles, wherein each particle includes a substrate substantially coated with an outer layer. The outer layer can comprise aluminum, thus forming an aluminum coated particle. In one embodiment, the substrate can include a non-metallic powder such as an oxide compound and/or a fluoride compound. The oxide compound can include lithium oxide. The fluoride compound can include barium fluoride and/or calcium fluoride. In another embodiment, a second layer can be added to the substrate prior to the addition of the outer layer, for example, the second layer can be a moisture barrier layer. The addition of a moisture barrier layer can be used to prevent the premature degradation of the non-metallic powder. In one embodiment, the moisture barrier layer can comprise iron, manganese, nickel and/or any other suitable moisture barrier component.

In one embodiment, an aluminum coated particle can have a diameter ranging from about 50 μm to about 300 μm. In one embodiment, a substrate of a particle can range from about 70% to about 95% by weight of the particle. In another embodiment, a substrate of a particle can range from about 80% to about 88% by weight of the particle. In one embodiment, an outer layer of a particle can range from about 5% to about 30% by weight of the particle. In another embodiment, an outer layer of a particle can range from about 12% to about 20% by weight of the particle. In one embodiment, an outer layer of a particle can have a thickness ranging from about 2 μm to about 10 μm.

Aluminum coated particles as described herein can be prepared in a variety of ways. In one embodiment, the aluminum coated particles can be formed by chemical vapor deposition. Chemical vapor deposition can be a chemical process used to produce high-purity, high-performance solid materials. In a typical chemical vapor deposition process, a substrate is exposed to one or more precursors, which react and/or decompose on the substrate surface to produce the desired deposit layer, for example, aluminum. In one embodiment, an aluminum layer can be deposited on a substrate through a reaction involving tri-isobutyl aluminum and/or tri-ethyl aluminum. In another embodiment, the aluminum coated particles can be formed by physical vapor deposition. Physical vapor deposition can include any type of method to deposit thin films by some form of condensation of a vaporized form of a material (e.g., aluminum) onto various surfaces (e.g., substrate surface). In one embodiment, the coating method used in physical vapor deposition can involve physical processes such as high temperature vacuum evaporation or plasma sputter bombardment.

The presence of aluminum coated particles in the flux portion 20 can provide for a reduction of aluminum used in the welding electrode 10 illustrated in FIG. 1. In applications, such as welding, aluminum coated particles can act as denitriders and deoxidizers to eliminate nitrogen and oxygen from a weld pool. For example, aluminum coated particles can remove more oxygen and nitrogen from a weld pool, resulting in cleaner weld metal having enhanced physical properties. Having aluminum delivered in a flux portion via aluminum coated particles can provide more uniform distribution of the aluminum in the core of the electrode and can provide for a larger surface area making the aluminum more chemically reactive. Thus, in one embodiment, at least some of the aluminum which would normally be present in a flux portion of an electrode is replaced with aluminum coated particles. In one embodiment, a flux portion comprises up to about 5% to about 30% by weight of aluminum coated particles. In yet another embodiment, a flux portion comprises about 12% to about 20% by weight of aluminum coated particles. Of course, the overall percentage of aluminum coated particles present in a flux portion of an electrode can be a function of the electrode type, desired performance and construction.

In one embodiment, aluminum coated particles can completely replace aluminum in the overall electrode. Thus, if a conventional electrode comprises about 10% aluminum by weight of a flux portion, one embodiment of an electrode can comprise about 10% aluminum coated particles by weight of a flux portion with no added aluminum. Of course, it will be appreciated by those of ordinary skill in the art that, due to various manufacturing techniques, trace amounts of aluminum may exist in an electrode as a function of manufacturing processes and the materials used. Thus, the amount of intentionally added aluminum can be replaced with aluminum coated particles.

As illustrated in the example shown in Table 1, as the fraction of aluminum from aluminum coated particles increases in a flux portion, the amount of nitrogen and oxygen present during the welding process decreases.

TABLE 1

| Percentage of aluminum | | |
|---|---|---|
| in flux portion from | Amount | Amount |
| aluminum coated | of nitrogen | of oxygen |
| particles (wt %) | present | present |
| 19 | 0.0182 | 0.00510 |
| 35 | 0.0170 | 0.00450 |
| 50 | 0.0160 | 0.00395 |
| 66 | 0.0148 | 0.00336 |
| 81 | 0.0137 | 0.00280 |

Thus, the use of a material having aluminum coated particles in a flux portion of an electrode can provide for the reduction of the amount of aluminum present in a welding electrode without reducing the shielding performance of the welding electrode and without any adverse metallurgical effects in the resulting weld. In fact, using electrodes in accordance with various embodiments discussed herein can result in improved metallurgical properties over conventional electrodes because the overall amount of aluminum remaining in the weld is reduced.

In addition to the aluminum coated particles, in one embodiment other compounds such as aluminum metal powders and/or aluminum alloy powder (e.g., 55% Al, 45% Mg) can also be included in a flux portion. In one embodiment, the amount of aluminum from the aluminum coated particles in a flux portion ranges from about 10% to about 100% by weight of the total aluminum in the flux portion. In another embodiment, the amount of aluminum from the aluminum coated particles in a flux portion ranges from about 19% to about 81% by weight of the total aluminum in the flux portion.

It is noted that, depending on the reactivity of aluminum coated particles, the percentages of aluminum coated particles utilized in an electrode may need to be adjusted to achieve a desired performance. Thus, it will be appreciated that one skilled in the art can determine the appropriate amount of aluminum coated particles employed, whether the aluminum coated particles is combined with aluminum, or is used by itself in forming a particular electrode. As such, the overall amount of aluminum coated particles used can be a function of the desired performance of an electrode with regard to its ability to provide the needed deoxidization and denitridation and produce a weld having desirable metallurgical properties, such as toughness.

Aluminum coated particles can generally be amorphous thus placement of aluminum coated particles in a material forming a flux portion of a welding electrode is convenient from a manufacturing perspective. Aluminum coated particles can be added to a flux portion of a welding electrode during a mixing process to form the flux portion being added to the electrode. A flux portion is then added to form a final welding electrode during a manufacturing process. As discussed herein, a flux portion can be substantially surrounded by a metallic electrode portion and serve as a core of an electrode. It will be appreciated that a metallic electrode portion can be formed from any suitable metal compound(s) and/or alloy(s) used in any applicable welding applications. Moreover, an electrode can be manufactured to serve many welding applications, and, as such, it will be appreciated by one skilled in the art that the physical dimension of an electrode (e.g., the diameter of the electrode) and integration of a flux portion as part of an electrode are similar to that of known welding electrodes.

Other embodiments are herein described in detail in connection with the drawing of FIG. 2. FIG. 2 illustrates a cross-section of a welding wire electrode 100. Welding wire electrode 100, as illustrated in FIG. 2, depicts an embodiment of a wire electrode in which a core material portion 200 can be substantially contained within a metal sheath portion 300 and the core material 200 is contained within a core of the welding wire electrode 100. The composition of metal sheath 300 includes, but is not limited to, steel, nickel, aluminum, and other metals and alloys known to those skilled in the art of manufacturing welding wires. In the configuration represented in FIG. 2, the core material portion 200 is employed to provide reactive core particles or metal alloying compounds during a welding operation in order to deliver the metal alloying compounds into the weld metal. In one embodiment, the core material ranges from about 5% to about 50% by weight of the welding wire electrode. In another embodiment, the core material ranges from about 10% to about 30% by weight of the welding wire electrode.

The welding wire electrodes are used in many different types of welding operations, but are primarily suited for a hot wire welding process. One such hot wire process is the hot wire GTAW, which is a further development of the Gas Tungsten Arc Welding or Tungsten Inert Gas process. The GTAW process initially used an electric arc to melt the base material and argon gas to shield the molten weld puddle. Hot wire GTAW as developed in which filler metal in the form of a wire was added to welds in the GTA welding process. With conventional GTAW, the filler wire is introduced into the leading edge of the weld puddle in the cold state (i.e. ambient temperature). Energy from the arc is required to melt the wire reducing the efficiency of the process. In hot wire welding, the filler wire is resistance heated until close to the melting point and added to the weld puddle behind the tungsten. This prevents the wire from chilling the weld pool and allow the filler metal to flow out across the weld puddle behind the tungsten typically resulting in a smooth and uniform weld bead. Since nearly all of the energy of the welding arc is available for penetration or to generate the weld pool and fusion, a two to three time faster travel speed can be realized.

In one embodiment, the welding wire electrodes are used in a hot wire process including, but not limited to, a hot wire laser hybrid process, a hot wire tandem process, a hot wire tungsten inert gas process, and a hot wire electron beam process.

The hot wire welding process provides the benefit of delivering the particles of the metal alloying compounds directly into the weld puddle without having them react in the arc, thereby protecting the alloying compounds from oxidation encountered in the arc during the welding operation. In order to achieve the delivery of the metal alloying compounds into the weld puddle during the hot wire welding process, at least one layer of a metallic coating is deposited onto the outer surface of each particle of the metal alloying compounds.

In one embodiment, a welding wire electrode for use with a hot wire welding process is provided. The welding wire electrode includes a metal sheath including a core, and a core material contained within the core of the metal sheath, wherein the core material includes particles of at least one metal alloying compound, wherein each of the particles has an outer surface, wherein at least one layer of a metallic coating is deposited onto the outer surface of each particle by a vapor deposition process to form a metallic coated particle, and wherein each of the metallic coated particles are deposited into a weld puddle formed during the hot wire welding process.

In one embodiment, the metal alloying compound includes metal carbides, metal borides, metal sulfides, metal nitrides, metal oxides, graphite, diamond particles and mixtures thereof. Representative metal carbides include titanium carbide, zirconium carbide, hafnium carbide, vanadium carbide, niobium carbide, tantalum carbide, chromium carbide, molybdenum carbide, and tungsten carbide. Representative metal borides include nickel boride, cobalt boride, titanium boride, rhenium boride, zirconium boride, and hafnium boride. Representative metal sulfides include tungsten sulfide and molybdenum sulfide. Representative metal nitrides include titanium nitride, boron nitride, chromium nitride, zirconium nitride, vanadium nitride, niobium nitride, tantalum nitride, tungsten nitride and hafnium nitride.

The metallic coating deposited onto the outer surface of each particle of the metal alloying compounds includes a metal including nickel, cobalt, chromium, iron, aluminum, magnesium, titanium, zirconium, manganese, and silicon.

Metallic coated particles as described herein can be prepared in a variety of ways. In one embodiment, the metallic coated particles are formed by chemical vapor deposition. Chemical vapor deposition is a chemical process used to produce high-purity, high-performance solid materials. In a typical chemical vapor deposition process, a substrate is exposed to one or more precursors, which react and/or decompose on the substrate surface to produce the desired deposit layer. In another embodiment, the metallic coated particles are formed by physical vapor deposition. Physical vapor deposition can include any type of method to deposit thin films by some form of condensation of a vaporized form of a material (e.g., nickel) onto various surfaces (e.g., substrate surface). In one embodiment, the coating method used in physical vapor deposition can involve physical processes such as high temperature vacuum evaporation or plasma sputter bombardment.

In one embodiment, a first layer of a first metallic coating is deposited onto the outer surface of each particle and a second layer of a second metallic coating is deposited onto the first layer of the first metallic coating, wherein the first metallic coating and the second metallic coating comprise the same metal. In this embodiment, a first layer of a first metallic coating, such as nickel, is deposited onto the outer surface of each particle and then a second layer of a nickel metallic coating is deposited onto the first nickel metallic coating of the particle.

In another embodiment, a first layer of a first metallic coating is deposited onto the outer surface of each particle and a second layer of a second metallic coating is deposited onto the first layer of the first metallic coating, wherein the first metallic coating and the second metallic coating comprise different metals. In this embodiment, a first layer of a first metallic coating, such as cobalt, is deposited onto the outer surface of each particle and then a second layer of a nickel metallic coating is deposited onto the first cobalt metallic coating of the particle.

The metallic coating deposited onto the outer surface of each particle of the metal alloying compound, as described herein, provides protection against oxidation that is encountered in the arc during the welding process. The metallic coating also provides an increase in the recovery of the metal alloying compounds in the deposited weld metal since the metal alloying compounds are delivered directed into the weld puddle during the welding process. In addition to the protection against oxidation of the particles, the metallic coating can slow or inhibit the melting of the particles and, therefore, the formation of detrimental oxides, carbides, or other compounds that may be damaging to the performance of the deposited material. The metallic coating may also further act to produce a more uniform structure between the matrix and the particle, such as between a nickel matrix and an oxide.

The welding wire electrodes, as described herein, are useful for hard surfacing applications. Hard surfacing is a specialized welding process that deposits an alloy on a metallic part to return worn areas to their original dimensions and/or protect new metal parts against wear. The process provides equipment with significant abrasion and impact resistance and it also provides the benefit of reducing downtime for replacing broken or worn parts.

The two primary hard surfacing processes include overlay and build-up. In the overlay process, additional protective layers of welds are added to a metal substrate in order to provide enhanced wear resistance and corrosion resistance. The build-up process is a process in which layers of welds are placed on a metal substrate, such as metal parts, in order to return the metal parts to their original dimensions. The build-up process provides excellent protection against impact, but offers low abrasion resistance. Combinations of the build-up and overlay processes can be used to restore older metal parts to size and then protect them against wear and corrosion.

In one embodiment, a method of hard surfacing a metal workpiece is provided. The hard surfacing method includes providing a metal workpiece. A particulate metal alloying compound including a plurality of particles is prepared, wherein each of the particles has an outer surface, and wherein at least one layer of a metallic coating is deposited onto the outer surface of each particle to form a metallic coated particle. The method also includes preparing a core material including the metallic coated particles and forming a cored wire electrode by placing the core material into a metal sheath. The cored wire electrode is fed toward the workpiece and then means for welding creates a weld puddle and delivers the cored wire electrode into the weld puddle, wherein at least a portion of the cored wire electrode is melted and the metallic coated particles are deposited into the weld puddle.

The means for welding is a hot wire process and includes a hot wire laser hybrid process, a hot wire tandem process, a hot wire tungsten inert gas process, and an hot wire electron beam process.

The welding wire electrodes, as described herein, are also useful for providing metal alloying compounds, including metal sulfides such as tungsten sulfide and molybdenum sulfide, in the production of metal bearings. These metal sulfides, when they are incorporated in the metal matrix of the bearings, provide enhanced lubricating properties, which reduces the amount of friction the bearings encounter during use, and ultimately reduces the wear rate of the bearings.

The foregoing description of embodiments and examples has been presented for purposes of illustration and description. It is not intended to be exhaustive or to limit the invention to the forms described. Numerous modifications are possible in light of the above teachings. Some of those modifications have been discussed, and others will be understood by those skilled in the art. The embodiments were chosen and described in order to best illustrate various embodiments as are suited to the particular use contemplated. It is hereby intended that the scope of the invention be defined by the claims appended hereto.

What is claimed is:

1. A welding wire electrode comprising:
a metal sheath including a core; and
a core material contained within the core of the metal sheath, wherein the core material includes particles of at least one metal alloying compound, wherein each of the particles has an outer surface, and wherein at least one layer of a metallic coating is deposited onto the outer surface of each particle to form a metallic coated particle.

2. The welding wire electrode of claim 1, wherein the at least one alloying compound is selected from the group consisting of a metal carbide, a metal boride, a metal sulfide, a metal nitride, a metal oxide, graphite, diamond particles, and mixtures thereof.

3. The welding wire electrode of claim 2, wherein the metal carbide is selected from the group consisting of titanium carbide, zirconium carbide, hafnium carbide, vanadium carbide, niobium carbide, tantalum carbide, chromium carbide, molybdenum carbide, and tungsten carbide.

4. The welding wire electrode of claim 2, wherein the metal boride is selected from the group consisting of nickel boride, cobalt boride, titanium boride, rhenium boride, zirconium boride, and hafnium boride.

5. The welding wire electrode of claim 2, wherein the metal sulfide is selected from the group consisting of tungsten sulfide and molybdenum sulfide.

6. The welding wire electrode of claim 2, wherein the metal nitride is selected from the group consisting of titanium nitride, boron nitride, chromium nitride, zirconium nitride, vanadium nitride, niobium nitride, tantalum nitride, tungsten nitride and hafnium nitride

7. The welding wire electrode of claim 1, wherein metallic coating comprises a metal selected from the group consisting of nickel, cobalt, chromium, iron, aluminum, magnesium, titanium, zirconium, manganese, and silicon.

8. The welding wire electrode of claim 1, wherein the metallic coating is deposited onto the outer surface of each particle by a process selected from the group consisting of chemical vapor deposition and physical vapor deposition.

9. The welding wire electrode of claim 1, wherein the core material ranges from about 5% to about 50% by weight of the welding wire electrode.

10. The welding wire electrode of claim 9, wherein the core material ranges from about 10% to about 30% by weight of the welding wire electrode.

11. The welding wire electrode of claim 1, wherein a first layer of a first metallic coating is deposited onto the outer surface of each particle and a second layer of a second metallic coating is deposited onto the first layer of the first metallic coating.

12. The welding wire electrode of claim 11, wherein the first metallic coating and the second metallic coating comprise the same metal.

13. The welding wire electrode of claim 11, wherein the first metallic coating and the second metallic coating comprise different metals.

14. A method of hard surfacing a metal workpiece, the method comprising the steps of:
providing a metal workpiece;
preparing a particulate metal alloying compound including a plurality of particles, wherein each of the particles has an outer surface, and wherein at least one layer of a metallic coating is deposited onto the outer surface of each particle to form a metallic coated particle;
preparing a core material including the metallic coated particles;
forming a cored wire electrode by placing the core material into a metal sheath;
feeding the cored wire electrode toward the workpiece; and
means for welding to create a weld puddle and deliver the cored wire electrode into the weld puddle, wherein at least a portion of the cored wire electrode is melted and the metallic coated particles are deposited into the weld puddle.

15. The method of claim 14, wherein the at least one alloying compound is selected from the group consisting of a metal carbide, a metal boride, a metal sulfide, a metal nitride, a metal oxide, graphite, diamond particles, and mixtures thereof.

16. The method of claim 14, wherein metallic coating comprises a metal selected from the group consisting of nickel, cobalt, chromium, iron, aluminum, magnesium, titanium, zirconium, manganese, and silicon.

17. The method of claim 14, wherein the metallic coating is deposited onto the outer surface of each particle by a process selected from the group consisting of chemical vapor deposition and physical vapor deposition.

18. The method of claim 14, wherein the means for welding is a hot wire process.

19. The method of claim 18, wherein the hot wire process is selected from the group consisting of a hot wire laser hybrid process, a hot wire tandem process, a hot wire tungsten inert gas process, and a hot wire electron beam process.

20. A welding wire electrode for use with a hot wire welding process, the electrode comprising:
a metal sheath including a core; and
a core material contained within the core of the metal sheath, wherein the core material includes particles of at least one metal alloying compound, wherein each of the particles has an outer surface, wherein at least one layer of a metallic coating is deposited onto the outer surface of each particle by a vapor deposition process to form a metallic coated particle, and wherein each of the metallic coated particles are deposited into a weld puddle formed during the hot wire welding process.
